(19) United States
(12) Patent Application Publication
(10) Pub. No.: US 2017/0317385 A1
(43) Pub. Date: Nov. 2, 2017

(54) Electrolyte Compositions For Rechargeable Lithium Ion Batteries

(71) Applicant: BASF CORPORATION, FLORHAM PARK, NJ (US)

(72) Inventors: Zhenghua Zhang, Jiangsu (CN); Xueshan Hu, Jiangsu (CN); Jianfei Zhang, Jiangsu (CN)

(73) Assignee: BASF CORPORATION, FLORHAM PARK, NJ (US)

(21) Appl. No.: 15/533,668

(22) PCT Filed: Dec. 17, 2014
(86) PCT No.: PCT/CN2014/094032

§ 371 Date: Jun. 7, 2017

(51) Int. Cl. H01M 10/0567; H01M 10/0525; H01M 10/0568; H01M 10/0569

(52) U.S. Cl. CPC H01M 10/0567; H01M 10/0569; H01M 10/0525; H01M 10/0568; H01M 2300/004

(57) ABSTRACT

One or more additives are selected from the group consisting of a) tertiary amines, b) amides, c) pyridine compounds, d) organophosphorus compounds, e) phosphonitrilic compounds, f) organoboron compounds, g) borate salts, h) anhydrides and i) nitrites are effective towards preventing color formation in electrolyte compositions for secondary Li ion batteries, which electrolyte compositions contain an organic solvent, one or more lithium salts and one or more cyclic sulfate additives. Advantageously, a combination of one or more compounds selected from the group consisting of a) tertiary amines, b) amides, c) pyridine compounds, d) organic phosphorus compounds and e) phosphonitrilic compounds is employed together with one or more compounds selected from the group consisting of f) organoboron compounds, g) borate salts, h) anhydrides and i) nitriles.

This invention is aimed at non-aqueous electrolyte compositions for lithium ion batteries.

Electrolyte compositions for use in lithium ion batteries typically contain a carbonate solvent and a lithium salt such as LiPF₆. Certain additives may be employed in the electrolyte compositions, for instance solid electrolyte interface improvers, cathode protection agents, LiPF₆ stabilizers, overcharge protectors, flame retardants, Li deposition improvers, solvation enhancers, corrosion inhibitors, wetting agents and viscosity adjusting agents.

Ethylene sulfate, or 1,3,2-dioxathiolane 2,2-dioxide (DTD), has been proposed as an additive to improve low temperature performance of secondary lithium batteries, for example as taught in U.S. Pat. No. 8,822,085.

However, sulfate additives result in undesirable color formation of electrolyte compositions containing lithium salts upon storage. Surprisingly, it has been found that certain coadditives employed together with sulfate additives inhibit this color formation.

Disclosed is an electrolyte composition stabilized against color formation comprising an organic solvent, one or more lithium salts,

one or more cyclic sulfate additives and

one or more additives selected from the group consisting of a) tertiary amines, b) amides, c) pyridine compounds, d) organophosphorus compounds, e) phosphonitrilic compounds, f) organoboron compounds, g) borate salts, h) anhydrides and i) nitriles.

### DETAILED DESCRIPTION

Rechargeable lithium ion batteries (cells) comprise an anode capable of intercalating and disintercalating lithium ions, a cathode and a non-aqueous electrolyte solution of a lithium salt in an organic solvent. The electrodes are in contact with the electrolyte and are separated by a separator.

Cathode active materials include one or more compounds selected from the group consisting of lithium cobalt oxide, lithium nickel cobalt manganese oxide (NCM, LiNiₓMn_{y}Co_{z}O₂), lithium manganese oxide (LMO, LiMn₂O₄), lithium nickel oxide and lithium iron phosphate (LFP, LiFePO₄).

Anode active materials include carbon and graphitic materials such as natural graphite, artificial graphite, expanded graphite, graphene, carbon fiber, non-graphitizable carbon, carbon black, carbon nano tube, fullerene and activated carbon; metals alloyable with lithium such as Al, Si, Sn, Ag, Bi, Mg, Zn, In, Ge, Pb, Pd, Pt and Ti and compounds including such elements; composite materials of the metals or their compounds and the carbon or graphite materials; and lithium-containing nitrides. For example, crystalline carbon, amorphous carbon, silicon-based active materials, tin-based active materials, silicon-carbon-based active materials and mixtures thereof may be employed as anode active materials.

In addition to the cathode and anode active materials, the electrodes may further include binders and/or conductive materials and/or other additives. The electrode assemblies may include these mixtures in adherence to a current collector such as a metal foil.

The binder assists in coupling the active material and the conductive material and the mixture to the current collector. Binders include poly(tetrafluoroethylene) (PTFE), a copolymer of acrylonitrile and butadiene (NBR), polyvinylidene fluoride (PvDF), polyvinyl alcohol, carboxy methyl cellulose (CMC), starch, hydroxy propyl cellulose, regenerated cellulose, polyvinylpyrrolidone, tetrafluoroethylene, polyethylene, polypropylene, ethylene-propylene-diene polymer (EPDM), sulfonated-EPDM, styrene-butadiene rubber (SBR), fluorine rubber, copolymers thereof and mixtures thereof. Binders may be employed from about 1 to about 50 weight %, based on the total weight of electrode assembly.

Conductive materials may be from about 1 to about 20 weight %, based on the total weight of the electrode assembly. Conductive materials include graphitic materials such as natural graphite, artificial graphite, a carbon black such as acetylene black, Ketjen black, channel black, furnace black or lamp black, conductive fibers such as carbon fiber or metal fiber, metal powders such as carbon fluoride, aluminum or nickel powder, conductive metal oxides such as zinc oxide, potassium titanate or titan oxide and other conductive materials such as polyphenylene derivatives.

A filler may be employed as a component for controlling expansion of the anode. Fillers include olefin-based polymers such as polyethylene or polypropylene and fibrous material such as glass fiber or carbon fiber.

A separator is interposed between the cathode and the anode which is for instance an insulating thin film ensuring high ion transmission. The separator generally has a pore size of about 0.01 to about 10 microns and a thickness of about 5 to about 300 microns. Separator materials include sheets or non-woven fabrics comprising materials including glass fiber, cotton, nylon, polyester, polyethylene, polypropylene, polyvinyl chloride, polytetrafluoroethylene and kraft paper.

The lithium secondary battery may for example be a coin-type battery having a cathode, an anode and a single-layer or multi-layer separator or a cylindrical or angled battery having a cathode, an anode and a roll-type separator.

The cathode may be prepared by mixing cathode active material with conductive material and/or a binder and a solvent, coating a metal foil with the mixture and heating and rolling. The anode may be prepared by mixing anode active material with a binder and solvent, coating a metal foil with the mixture and heating and rolling.

The lithium secondary battery according to the present invention may be prepared by inserting an electrode group having a cathode and an anode into a battery case and injecting the non-aqueous electrolyte solution of the present invention into the case. The battery case may have a metal can shape or a pouch shape made of metal laminate.

The organic solvent typically comprises one or more solvents selected from the group consisting of organic carbonates, sulfones, sulfoxides, esters, lactones, ethers and glymes.

The organic solvent may consist essentially or consist of one or more organic carbonates.

The present electrolyte compositions are anhydrous, typically containing 10 ppm water, for instance 9, 8, 7, 6, 5 or 4 ppm water by weight, based on the total weight of the electrolyte composition.

Organic carbonates are cyclic or acyclic and include ethylene carbonate (EC), propylene carbonate (PC), trimethylene carbonate, 1,2-butylene carbonate (BC), dimethyl carbonate (DMC), diethyl carbonate (DEC), ethylmethyl carbonate (EMC), dipropyl carbonate, vinylene carbonate, difluoroethylene carbonate and monofluoroethylene carbonate.

Sulfones and sulfoxides include methylsulfonylmethane (MSM or dimethylsulfone), ethylmethylsulfone, sulfolane and dimethylsulfoxide (DMSO).

Esters and lactones include γ-butyrolactone (GBL), γ-valerolactone, δ-valerolactone, ethyl acetate (EA), 2-methoxyethyl acetate, 2-ethoxyethyl acetate, 2-butoxyethyl acetate, 2-(2-butoxyethoxy)ethyl acetate (diethylene glycol butyl ether acetate, DBA), ethylene glycol diacetate (EGDA), ethyl propionate, propyl propionate, 3-ethoxy ethyl propionate (EEP), methyl butyrate (MB), n-amyl acetate (NAAC), propylene glycol methyl ether acetate (PMA), ethyl butyrate (EB), diethyl malonate, dimethyl malonate and dibasic ester mixture (DBE).

Ethers and glymes include dimethoxymethane (DMM), diethoxymethane, 1,2-dimethoxyethane (DME or ethyleneglycol dimethylether or glyme), diglyme, triglyme, tetraglyme, ethyleneglycol diethylether (DEE), ethyleneglycol dibutylether, diethyleneglycol diethylether, tetrahydrofuran (THF), 2-methyltetrahydrofuran (2-MeTHF), 1,3-dioxane, 1,3-dioxolane (DIOX), 4-methyl-1,3-dioxolane (4-MeDIOX), 2-methyl-1,3-dioxolane (2-MeDIOX), 1,4-dioxane, dimethylether, ethylmethylether, diethylether, di-n-butylether, di-t-butylether, di-isopropylether, methyl-t-butylether, ethyl-t-butylether and t-amyl-methylether.

For example, at least two different solvents are advantageously used in combination, such as a combination of cyclic carbonate and linear carbonate, a combination of cyclic carbonate and lactone, a combination of cyclic carbonate, lactone and ester, a combination of cyclic carbonate, linear carbonate and lactone, a combination of cyclic carbonate, linear carbonate and ether or a combination of cyclic carbonate, linear carbonate and linear ester. Among them, a combination of cyclic carbonate and linear carbonate or a combination of cyclic carbonate, lactone and ester is preferred. A weight:weight ratio of cyclic carbonate(s) to linear carbonate(s) is for example from about 1:9 to about 7:3.

For example, the organic solvent contains a cyclic carbonate such as ethylene carbonate or propylene carbonate and one or more linear carbonates selected from dimethyl carbonate, ethylmethyl carbonate and diethyl carbonate. For example, the organic solvent comprises ethylene carbonate, ethylmethyl carbonate and diethyl carbonate.

The electrolyte compositions comprise one or more suitable lithium salts. Lithium salts include LiPF₆, LiClO₄, LiN(CF₃SO₂)₂, LiAsF₆ and LiCF₃SO₃. For example, the electrolyte compositions contain LiPF₆. The lithium salts are generally employed in the organic solvent at a level of from about 0.5 mol/L (M) to about 2.5 M, from about 0.5 M to about 2.0 M, from about 0.7 M to about 1.6 M or from about 0.8 M to about 1.2 M.

The present lithium salts do not include lithium tetrafluoroborate. The borate salts g) do include lithium tetrafluoroborate.

The cyclic sulfate additives are for example of formula

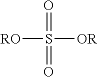

where the R groups together are hydrocarbylene.

For example sulfate additives included are 1,3,2-dioxathiolane 2,2-dioxide (ethylene sulfate), 1,3-propanediol cyclic sulfate, propylene sulfate (4-methyl-1,3,2-dioxathiolane 2,2-dioxide), 4-ethyl-1,3,2-dioxathiolane 2,2-dioxide and 4-propyl-1,3,2-dioxathiolane 2,2-dioxide.

Ethylene sulfate, or 1,3,2-dioxathiolane 2,2-dioxide (DTD) is represented as:

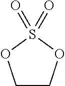

Tertiary amines include compounds of formula NR₁R₂R₃ where R₁, R₂ and R₃ are each hydrocarbyl or where R₁ and R₂ and/or R₁ and R₃ and/or R₂ and R₃ together are hydrocarbylene. Tertiary amines include for instance triethylamine, tributylamine, N,N,N′,N″,N″-pentamethyldiethylenetriamine (PMDTA), N,N,N′,N″,N′″,N″″-hexamethyltriethylenetetraamine (HMTTA), N,N,N′,N′-tetramethylethylenediamine (TMEDA) and triethylenediamine (1,4-diazabicyclo[2.2.2]octane or DABCO). Triethylenediamine is an example where R₁ and R₂ and R₁ and R₃ and R₂ and R₃ together are hydrocarbylene.

Amides include organic amides and phosphoramides. Organic amides include compounds of formula R₁R₂NC(O)R₃ where R₁, R₂ and R₃ are each hydrogen or hydrocarbyl or R₁ and R₂ and/or R₁ and R₃ and/or R₂ and R₃ together are hydrocarbylene. Amides include N,N-dimethyl acetamide, N,N-dimethyl-trifluoroacetamide, N,N-diethyl-trifluoroacetamide, N-methyl-trifluoracetamide, 1-methyl-2-pyrrolidinone and hexamethylphosphoramide (HMPA).

Pyridine compounds include compounds of formula

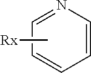

where Rx is hydrogen, halogen or hydrocarbyl. Included are pyridine, 2,2-dipyridyl, 4,4′-dipyridyl, 4-bromopyridine, 3-chloropyridine, 2-vinylpyridine and 4-tert-butylpyridine.

Organophosphorus compounds include compounds of formula

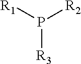

where R₁, R₂ and R₃ are each hydrocarbyl groups or R₁ and R₂ and/or R₁ and R₃ and/or R₂ and R₃ together are hydrocarbylene. Organophosphorus compounds include triphenylphosphine, triethylphosphine, tripropylphosphine, triisobutylphosphine, trihexylphosphine, trioctylphosphine, tributylphosphine, tris-pentafluorophenylphosphine and tris(4-fluorophenyl) phosphine (TFPP).

Phosphonitrilic compounds include compounds of formula

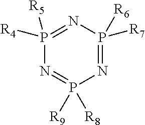

where R₄, R₅, R₆, R₇, R₅ and R₉ are selected from alkoxy, halogen and hydrocarbyl.

Phosophonitrilic compounds include hexamethoxycyclotriphosphazene, phosphonitrilic chloride trimer and phosphonitrilic fluoride trimer.

Organoboron compounds include compounds of formula

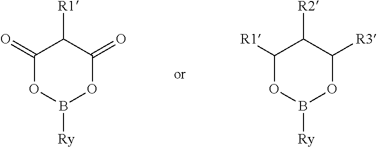

where Ry is hydrogen, alkoxy or hydrocarbyl and R1′, R2′ and R3′ are hydrogen or hydrocarbyl. Organoboron compounds include 4,4,6-trimethyl-1,3,2-dioxaborinane, 2-methoxy-4,4,6-trimethyl-1,3,2-dioxaborinane, 2-ethoxy-4,4,6-trimethyl-1,3,2-dioxaborinane, 2-isopropoxy-4,4,6-trimethyl-1,3,2-dioxaborinane, 2-butoxy-4,4,6-trimethyl-1,3,2-dioxaborinane, vinylboronic acid 2-methyl-2,4-pentanediol ester, phenylboronic acid neopentylglycol ester and phenylboronic acid 1,3-propanediol ester.

Borate salts include alkali metal salts of borates selected from orthoborate, tetrahydroxyborate, tetraborate, tetraphenylborate, [B(3,5-(CF₃)₂C₆H₃)₄]⁻ (BARF), B(C₂O₄)₂⁻ (bis(oxalato)borate or BOB), difluoro(oxalato)borate (dFOB), di(trifluoroacetato)oxalatoborate (D(Ac)OB), B(C₆F₅)₄⁻ and BF₄⁻ (tetrafluoroborate).

For instance, borate salts include lithium bis(oxalate)borate (LiBOB), lithium difluoro(oxalate)borate (LidFOB) and lithium tetrafluoroborate.

Anhydrides are cyclic or acyclic and include organic and phosphonic anhydrides. Organic anhydrides include compounds of formula

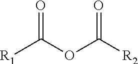

where R₁ and R₂ are hydrocarbyl or together are hydrocarbylene.

Included are succinic anhydride, glutaric anhydride, phthalic anhydride, acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride and propylphosphonic anhydride.

Nitriles include organic mono and di-nitriles, including compounds of formula

R₁—CN or NC—Rz-CN

where R₁ is hydrocarbyl and Rz is hydrocarbylene.

for example acetonitrile, propionitrile, butyronitrile, isobutyronitrile, 1,2-dicyanoethane, succinonitrile, 1,5-dicyanopentane, hexanedinitrile (adiponitrile), glutaronitrile and fumaronitrile.

Hydrocarbyl is for instance alkyl, alkenyl, alkynyl, cycloalkyl, cycloalkenyl, aryl or aralkyl, which may be substituted by one or more groups selected from the group consisting of halogen, hydroxy, C₁-C₄alkoxy, thio, C₁-C₄alkylthio, amino, C₁-C₄alkylamino, di-C₁-C₄alkylamino, nitro, cyano, —COOH and —COO⁻. Hydrocarbyl may also be interrupted by one or more groups selected from the group consisting of —O—, —S—, —NH— and —N(C₁-C₄alkyl)-. Hydrocarbyl may be both substituted by one or more of said groups and interrupted by one or more of said groups. For instance alkyl, alkenyl, alkynyl, cycloalkyl, cycloalkenyl, aryl or aralkyl may be substituted by one to three groups selected from the group consisting of chloro, hydroxy, methoxy, ethoxy, propoxy, butoxy, thio, methylthio, methylamino, ethylamino, propylamino, butylamino, dimethylamino, diethylamino, dipropylamino, dibutylamino, —COOH, —COO⁻, cyano and nitro and/or may be interrupted by one to three groups selected from the group consisting of —O—, —S—, —NH— and —N(C₁-C₄alkyl)-.

Hydrocarbylene is divalent hydrocarbyl, for instance alkylene, alkenylene, alkynylene, cycloalkylene, arylene or aralkylene. Hydrocarbylene may be substituted and/or interrupted as is hydrocarbyl.

When two groups together are hydrocarbylene, this means that together with the heteroatom(s) they are bound to, a resulting ring is formed. The ring is for example 5- or 6-membered. The ring may contain a further heteroatom and may be saturated or unsaturated. Hydrocarbylene in this case is for instance —(CH₂)₂—, —(CH₂)₃—, —(CH₂)₄— or —(CH₂)₅—. Hydrocarbylene may be interrupted and/or substituted as for hydrocarbyl.

Hydrocarbyl and hydrocarbylene are bound to the attached atom through a carbon atom.

Alkyl is for instance from 1 to 25 carbon atoms, is branched or unbranched and includes methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl and docosyl.

Alkoxy is for instance C₁-C₂₅alkyloxy where the alkyl is as above, for instance methoxy, ethoxy, propoxy, isopropoxy, butoxy, tert-butoxy, etc.

Halogen is F, Cl, Br or I.

Haloalkyl is for instance C₁-C₂₅alkyl where alkyl is as above, substituted by one or more, for instance 1 to 3 halogen.

Perfluoroalkyl may be fully fluorinated, that is all hydrogens of the alkyl are replaced by F. Alternatively, perfluoroalkyl may be partly fluorinated, that is containing at least 2 groups selected from —CF₂— and —CF₃.

Alkenyl is an unsaturated version of alkyl, for instance allyl.

Alkynyl is alkyl containing a

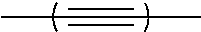

group, for instance, propargyl.

Cycloalkyl includes cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl.

Cycloalkenyl is an unsaturated version of cycloalkyl.

Aryl includes phenyl, o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethyl phenyl, 4-tert-butyl phenyl, 2-ethyl phenyl or 2,6-diethyl phenyl.

Aralkyl includes benzyl, α-methylbenzyl, α,α-dimethylbenzyl and 2-phenylethyl.

The cyclic sulfate compounds together with the present compounds a)-i), in total, are employed for example from about 0.01% to about 15% by weight, based on the total weight of the electrolyte composition. For example, these additives in total may be present from about 0.1 to about 12%, from about 0.2 to about 10%, from about 0.3 to about 8%, from about 0.4 to about 7% or from about 0.5 to about 5% by weight, based on the total weight of the electrolyte composition.

The cyclic sulfate compounds together with present compounds a)-i), in total, may be present at levels of about 0.6, about 0.8, about 0.9, about 1.0, about 1.1, about 1.2, about 1.4, about 1.6, about 1.8, about 2.0, about 2.2, about 2.4, about 2.6, about 2.8, about 3.0, about 3.2, about 3.4, about 3.6, about 3.8, about 4.0, about 4.2, about 4.4, about 4.6, about 4.8 or about 5.0 percent by weight, based on the total weight of the electrolyte composition.

The weight:weight ratio of the one or more cyclic sulfate compounds to the one or more present additives a)-i) is for instance about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1 or about 9:1 and ratios therebetween.

Advantageously, at least two different additives selected from tertiary amines, amides, pyridine compounds, organophosphorus compounds, phosphonitrilic compounds, organoboron compounds, borate salts, anhydrides and nitriles are employed in the present compositions. Advantageously, the at least two different additives are selected from different classes a)-i).

For example, one or more additives selected from the group consisting of a) tertiary amines, b) amides, c) pyridine compounds, d) organic phosphorus compounds and e) phosphonitrilic compounds are advantageously employed together with one or more additives selected from the group consisting of f) organoboron compounds, g) borate salts, h) anhydrides and i) nitriles.

For instance, an amide is advantageously employed together with one or more additives selected from the group consisting of borate salts, anhydrides and nitriles.

The at least two different additives of a)-i) may be employed in a weight:weight ratio of about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1 or about 9:1 and ratios therebetween.

The electrolyte compositions of the invention may advantageously comprise one or more further additives selected from the group consisting of solid electrolyte interface improvers, cathode protection agents, LiPF₆ stabilizers, overcharge protectors, flame retardants, Li deposition improvers, solvation enhancers, corrosion inhibitors, wetting agents and viscosity adjusting agents.

For instance, the electrolyte compositions may further contain one or more further additives selected from the group consisting of formulae (1) to (12)

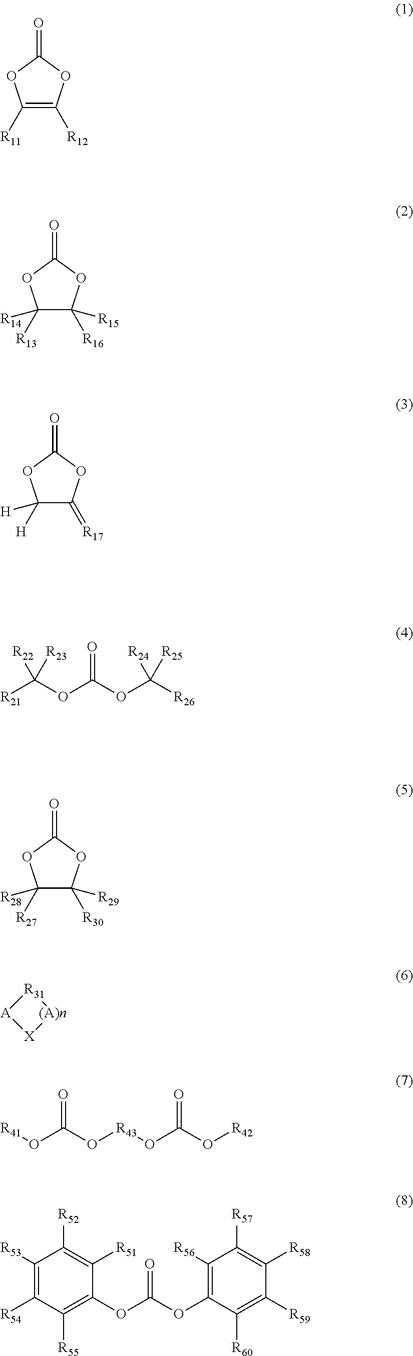

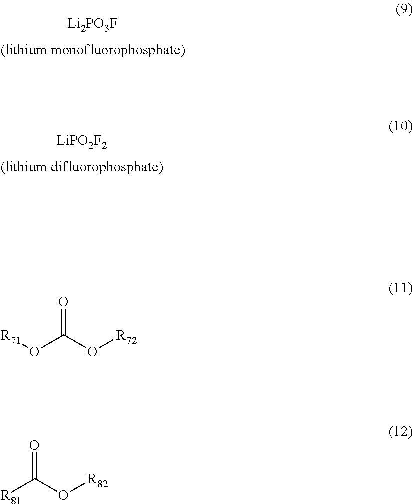

where
R₁₁ and R₁₂ are independently hydrogen, halogen, alkyl or haloalkyl;
R₁₃, R₁₄, R₁₅ and R₁₆ are independently hydrogen, halogen, alkyl, haloalkyl, vinyl or allyl, where at least one of R₁₃ to R₁₆ is vinyl or allyl;
R₁₇ is hydrogen or alkyl;
R₂₁ to R₂₆ are independently hydrogen, halogen, alkyl or haloalkyl, where at least one of R₂₁ to R₂₆ is halogen or haloalkyl;
R₂₇ to R₃₀ are independently hydrogen, halogen, alkyl or haloalkyl, where at least one of R₂₇ to R₃₀ is halogen or haloalkyl;
R₃₁ is an optionally substituted C₁-C₆alkylene, an optionally substituted C₂-C₆alkenylene or an optionally substituted cycloalkylene, A is C═O, SO or SO₂, n is 0 or 1 and X is oxygen (O) or sulfur (S);
R₄₁ and R₄₂ are independently an optionally substituted C₁-C₆alkyl, an optionally substituted C₂-C₅alkenyl or an optionally substituted C₂-C₆alkynyl and R₄₃ is an optionally substituted C₁-C₆alkylene, an optionally substituted C₂-C₆alkenylene, an optionally substituted C₂-C₆alkynylene or an optionally substituted cycloalkylene, where the substituent is for instance halogen or C₁-C₆alkyl;
R₅₁ to R₆₀ independently are an optionally substituted C₁-C₁₈alkyl, alkenyl, alkynyl, alkoxy or alkylamino, or two of R₅₁-R₆₀ together are hydrocarbylene, where the substituent halogen atom or C₁-C₆alkyl;
R₇₁ and R₇₂ are independently alkyl or haloalkyl; and
R₈₁ and R₈₂ are independently alkyl.

For example, suitable further additives include vinylene carbonate (1,3-dioxol-2-one), 4-vinyl-1,3-dioxolan-2-one, 4-fluoro-1,3-dioxolan-2-one, methylene ethylene carbonate, 1,3-propane sultone, 1,4-butyl sultone, prop-1-ene-1,3-sultone, 4-(4-methyl)-1,3,2-dioxathiolane-2-oxide) and 1,5,2,4-dioxadithiane-2,2,4,4-tetraoxide.

Further additives also include one or more ionic compounds selected from the group consisting of ionic liquids. Ionic liquids are ionic compounds that exhibit a melting point of ≦150° C. or ≦100° C.

For instance, ionic liquids contain a cation selected from the group consisting of formulae (a)-(h)

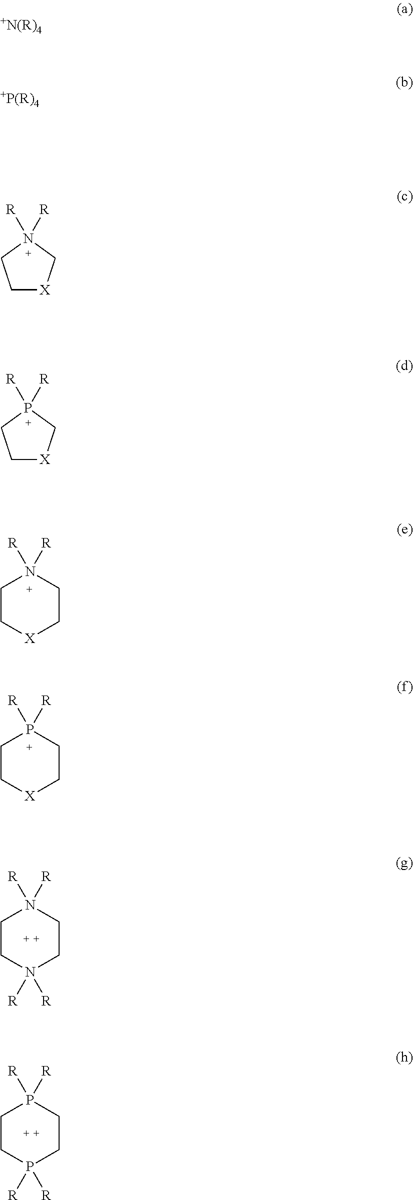

where
each R is independently H or C₁-C₁₆alkyl, for instance methyl, ethyl or propyl,
X is CH₂, O, S or NR where R is H or C₁-C₁₆alkyl, for instance H, methyl, ethyl or propyl
and contain an anion selected from the group consisting of

[F_{z}B(CₘF2ₘ₊₁)_{4-z}]⁻,

[F_{y}P(CₘF₂ₘ₊₁)_{6-y}]⁻,

[(CₘF₂ₘ₊₁)₂P(O)O]⁻,

[CₘF₂ₘ₊₁)₂P(O)O₂]²⁻,

[O—C(O)—CₘF₂ₘ₊₁]⁻,

[O—S(O)₂—CₘF₂ₘ₊₁]⁻,

[N(C(O)—CₘF₂ₘ₊₁)₂]⁻,

[N(S(O)₂—CₘF₂ₘ₊₁)₂]⁻,

[N(C(O)—CₘF₂ₘ₊₁)(S(O)₂—CₘF₂ₘ₊₁)]⁻,

[N(C(O)—CₘF₂ₘ₊₁)(C(O)F)]⁻,

[N(S(O)₂—CₘF₂ₘ₊₁)(S(O)₂F)]⁻,

[N(S(O)₂F)₂]⁻,

[C(C(O)—CₘF₂ₘ₊₁)₃]⁻,

[C(S(O)₂—CₘF₂ₘ₊₁)₃]⁻,

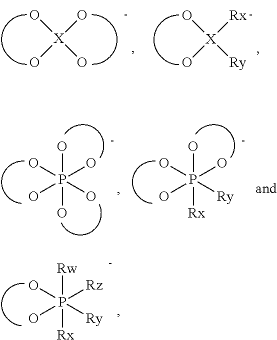

where
y is an integer of 1 to 5 and m is an integer of 1 to 8, for instance 1 to 4,
where any one CF₂ group may be replaced by O, S(O)₂, NR or CH₂,
where [symbol] is independently a bidentate group derived from the —OH groups of a 1,2- or 1,3-diol, a 1,2- or 1,3-dicarboxylic acid or from a 1,2- or 1,3-hydroxycarboxylic acid,

### X is B or Al,

R_{w}, Rₓ, R_{y} and R_{z} are independently halogen, C₁-C₂₀perfluoroalkyl, C₁-C₂₀alkoxy, C₁-C₂₀alkoxy which is partly or fully fluorinated, C₁-C₂₀alkyl-COO, C₁-C₂₀alkyl-COO which is partly or fully fluorinated.

Cations of ionic liquids include ammonium and phosphonium ions. Ammonium ions include imidazolium and pyrrolidinium. For instance 1-ethyl-3-methylimidazolium, 1-hexyl-3-methylimidazolium, 1-butyl-1-methylpyrrolidinium or trihexyl(tetradecyl)phosphonium.

Anions of ionic liquids include carboxylates, imides, methides, borates, phosphates, sulfonates and aluminates. For instance, included are F₂P(C₂F₅)₄⁻, F₃P(C₂F₅)₃⁻, F₄P(C₂F₅)₂⁻, F₂P(C₃F₇)₄⁻, F₃P(C₃F₇)₃⁻, F₄P(C₃F₇)₂⁻, F₂P(C₄F₉)₄⁻, F₃P(C₄F₉)₃⁻, F₄P(C₄F₉)₂⁻, perfluoroalkylcarboxylate, perfluoroalkylsulfonate, bis(perfluoroalkylsulfonyl)imide, (perfluoroalkylsulfonyl)(perfluoroalkylcarboxyl)imide, tris(perfluoroalkylsulfonyl)methide, trifluoroacetate, trifluoromethanesulfonate (triflate), bis(trifluoromethylsulfonyl)imide, tris(trifluoromethylsulfonyl)methide, spiro-oxo borates and spiro-oxo phosphates, for example bisoxalatoborate (BOB), difluorooxalatoborate (dFOB), di(trifluoroacetato)oxalatoborate (d(Ac)OB), trisoxalatophosphate, tetrafluorooxalatophosphate or di(trifluoroacetato)oxalatoaluminate.

Ionic liquids are also described for example in U.S. Pub. Nos. 2011/0045359 and 2014/0193707.

These further additives are for example employed at a level of from about 0.01% to about 15% by weight, based on the total weight of the electrolyte composition. For example, further additives may be employed from about 0.1 to about 10%, from about 0.2 to about 7% or from about 0.3 to about 5%, by weight, in total, based on the total weight of the electrolyte composition.

Further additives may be employed at a level, in total, of about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4 or about 2.5 percent by weight, based on the total weight of the electrolyte composition.

Anhydrous electrolyte compositions for secondary lithium ion batteries containing cyclic sulfate additives and lithium salts will discolor upon storage, for example turning an undesirable light brown, brown or dark brown color. This will occur for example at temperatures anywhere from about 20° C. and above. The present electrolyte compositions are stabilized against this undesirable color formation. Advantageously, the present electrolyte compositions are clear.

The terms “a” or “an” referring to elements of an embodiment may mean “one” or may mean “one or more”.

The term “about” refers to variation that can occur, for example, through typical measuring and handling procedures; through inadvertent error in these procedures; through differences in the manufacture, source, or purity of ingredients used; through differences in methods used; and the like. The term “about” also encompasses amounts that differ due to different equilibrium conditions for a composition resulting from a particular initial mixture. Whether or not modified by the term “about,” embodiments and claims include equivalents to the recited quantities.

All numeric values herein are modified by the term “about,” whether or not explicitly indicated. The term “about” generally refers to a range of numbers that one of skill in the art would consider equivalent to the recited value (i.e., having the same function and/or result). In many instances, the term “about” may include numbers that are rounded to the nearest significant figure.

A value modified by the term “about” of course includes the specific value. For instance, “about 5.0” must include 5.0.

The term “consisting essentially of” means that the composition, method or structure may include additional ingredients, steps and/or parts, but only if the additional ingredients, steps and/or parts do not materially alter the basic and novel characteristics of the claimed composition, method or structure.

U.S. patents, U.S. published patent applications and U.S. patent applications discussed herein are each hereby incorporated by reference.

Following are some embodiments of the invention.

E1. An electrolyte composition stabilized against color formation comprising an organic solvent, one or more lithium salts,

one or more cyclic sulfate additives and

one or more additives selected from the group consisting of a) tertiary amines, b) amides, c) pyridine compounds, d) organophosphorus compounds, e) phosphonitrilic compounds, f) organoboron compounds, g) borate salts, h) anhydrides and i) nitriles.

E2. A composition according to embodiment 1 where the cyclic sulfate additives are of formula

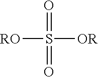

where the R groups together are hydrocarbylene; for example the sulfate additives are selected from the group consisting of 1,3,2-dioxathiolane 2,2-dioxide (ethylene sulfate), 1,3-propanediol cyclic sulfate, propylene sulfate (4-methyl-1,3,2-dioxathiolane 2,2-dioxide), 4-ethyl-1,3,2-dioxathiolane 2,2-dioxide and 4-propyl-1,3,2-dioxathiolane 2,2-dioxide.
E3. A composition according to embodiment 1 where the cyclic sulfate is ethylene sulfate.
E4. A composition according to any of the preceding embodiments where the organic solvent comprises one or more solvents selected from the group consisting of organic carbonates, sulfones, sulfoxides, esters, lactones, ethers and glymes.
E5. A composition according to any of the preceding embodiments where the organic solvent comprises one or more organic carbonates, for example one or more organic carbonates selected from the group consisting of ethylene carbonate (EC), propylene carbonate (PC), trimethylene carbonate, 1,2-butylene carbonate (BC), dimethyl carbonate (DMC), diethyl carbonate (DEC), ethylmethyl carbonate (EMC), dipropyl carbonate, vinylene carbonate, difluoroethylene carbonate and monofluoroethylene carbonate.
E6. A composition according to any of the preceding embodiments where the organic solvent contains ethylene carbonate and/or propylene carbonate and one or more organic carbonates selected from the group consisting of dimethyl carbonate, ethylmethyl carbonate and diethyl carbonate; for example the organic solvent contains ethylmethyl carbonate (EMC), diethyl carbonate (DEC) and ethylene carbonate.
E7. A composition according to any of the preceding embodiments where the lithium salts are selected from the group consisting of LiPF₆, LiClO₄, LiN(CF₃SO₂)₂, LiAsF₆ and LiCF₃SO₃.
E8. A composition according to any of the preceding embodiments where the lithium salt is LiPF₆.
E9. A composition according to any of the preceding embodiments where the lithium salts in total are present in the organic solvent at a level of from about 0.5 mol/L (M) to about 2.5 M, from about 0.5 M to about 2.0 M, from about 0.7 M to about 1.6 M or from about 0.8 M to about 1.2 M.
E10. A composition according to any of the preceding embodiments comprising one or more additives selected from the group consisting of a) tertiary amines.
E11. A composition according to any of the preceding embodiments comprising one or more additives selected from the group consisting of a) tertiary amines of formula NR₁R₂R₃ where R₁, R₂ and R₃ are each hydrocarbyl or where R₁ and R₂ and/or R₁ and R₃ and/or R₂ and R₃ together are hydrocarbylene; for instance one or more of triethylamine, tributylamine, N,N,N′,N″,N″-pentamethyldiethylenetriamine (PMDTA), N,N,N′,N″,N′″,N″″-hexamethyltriethylenetetraamine (HMTTA), N,N,N′,N′-tetramethylethylenediamine (TMEDA) and triethylenediamine (1,4-diazabicyclo[2.2.2]octane or DABCO).
E12. A composition according to any of the preceding embodiments comprising one or more additives selected from the group consisting of b) amides.
E13. A composition according to any of the preceding embodiments comprising one or more additives selected from the group consisting of b) phosphoramides and organic amides of formula R₁R₂NC(O)R₃ where R₁, R₂ and R₃ are each hydrogen or hydrocarbyl or R₁ and R₂ and/or R₁ and R₃ and/or R₂ and R₃ together are hydrocarbylene; for instance one or more of N,N-dimethyl acetamide, N,N-dimethyl-trifluoroacetamide, N,N-diethyl-trifluoroacetamide, N-methyl-trifluoracetamide, 1-methyl-2-pyrrolidinone and hexamethylphosphoramide (HMPA).
E14. A composition according to any of the preceding embodiments comprising one or more additives selected from the group consisting of c) pyridine compounds.
E15. A composition according to any of the preceding embodiments comprising one or more additives selected from the group consisting of c) pyridine compounds of formula

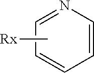

where Rx is hydrogen, halogen or hydrocarbyl; for instance one or more of pyridine, 2,2-dipyridyl, 4,4′-dipyridyl, 4-bromopyridine, 3-chloropyridine, 2-vinylpyridine and 4-tert-butylpyridine.
E16. A composition according to any of the preceding embodiments comprising one or more additives selected from the group consisting of d) organophosphorus compounds.
E17. A composition according to any of the preceding embodiments comprising one or more additives selected from the group consisting of d) organophosphorus compounds of formula

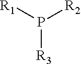

where R₁, R₂ and R₃ are independently hydrocarbyl or R₁ and R₂ and/or R₁ and R₃ and/or R₂ and R₃ together are hydrocarbylene; for example one or more of triphenylphosphine, triethylphosphine, tripropylphosphine, triisobutylphosphine, trihexylphosphine, trioctylphosphine, tributylphosphine, tris-pentafluorophenylphosphine and tris(4-fluorophenyl) phosphine (TFPP).
E18. A composition according to any of the preceding embodiments comprising one or more additives selected from the group consisting of e) phosphonitrilic compounds.
E19. A composition according to any of the preceding embodiments comprising one or more additives selected from the group consisting of e) phosponitrilic compounds of formula

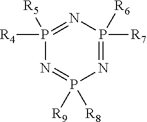

where R₄, R₅, R₆, R₇, R₈ and R₉ are independently alkoxy, halogen or hydrocarbyl; for example one or more of hexamethoxycyclotriphosphazene, phosphonitrilic chloride trimer and phosphonitrilic fluoride trimer.
E20. A composition according to any of the preceding embodiments comprising one or more additives selected from the group consisting of f) organoboron compounds.
E21. A composition according to any of the preceding embodiments comprising one or more additives selected from the group consisting of f) organoboron compounds of formula

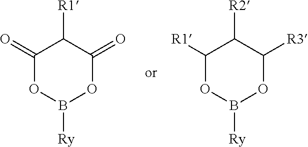

where Ry is hydrogen, alkoxy or hydrocarbyl and R1′, R2′ and R3′ are independently hydrogen or hydrocarbyl; for example one or more of 4,4,6-trimethyl-1,3,2-dioxaborinane, 2-methoxy-4,4,6-trimethyl-1,3,2-dioxaborinane, 2-ethoxy-4,4,6-trimethyl-1,3,2-dioxaborinane, 2-isopropoxy-4,4,6-trimethyl-1,3,2-dioxaborinane, 2-butoxy-4,4,6-trimethyl-1,3,2-dioxaborinane, vinylboronic acid 2-methyl-2,4-pentanediol ester, phenylboronic acid neopentylglycol ester and phenylboronic acid 1,3-propanediol ester.
E22. A composition according to any of the preceding embodiments comprising one or more additives selected from the group consisting of g) borate salts; for example alkali metal salts of borates selected from orthoborate, tetrahydroxyborate, tetraborate, tetraphenylborate, [B(3,5-(CF₃)₂C₆H₃)₄]⁻ (BARF), B(C₂O₄)₂⁻ (bis(oxalato)borate or BOB), difluoro(oxalato)borate (dFOB), di(trifluoroacetato)oxalatoborate (D(Ac)OB), B(C₆F₅)₄⁻ and BF₄⁻ (tetrafluoroborate).
E23. A composition according to any of the preceding embodiments comprising one or more additives selected from the group consisting of g) borate salts lithium bis(oxalate)borate (LiBOB), lithium difluoro(oxalate)borate (LidFOB) and lithium tetrafluoroborate.
E24. A composition according to any of the preceding embodiments comprising one or more additives selected from the group consisting of h) anhydrides.
E25. A composition according to any of the preceding embodiments comprising one or more additives selected from the group consisting of h) phosphonic anhydrides and anhydrides of formula

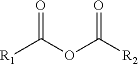

where R₁ and R₂ are independently hydrocarbyl or together are hydrocarbylene; for instance one or more of succinic anhydride, glutaric anhydride, phthalic anhydride, acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride and propylphosphonic anhydride.
E26. A composition according to any of the preceding embodiments comprising one or more additives selected from the group consisting of i) nitriles.
E27. A composition according to any of the preceding embodiments comprising one or more additives selected from the group consisting of i) nitriles of formula

R₁—CN or NC—Rz-CN

where R₁ is hydrocarbyl and Rz is hydrocarbylene; for instance one or more of acetonitrile, propionitrile, butyronitrile, isobutyronitrile, 1,2-dicyanoethane, succinonitrile, 1,5-dicyanopentane, hexanedinitrile (adiponitrile), glutaronitrile and fumaronitrile.
E28. A composition according to any of the preceding embodiments where the cyclic sulfate compounds together with the compounds a)-i), in total, are employed for example from about 0.01 to about 15%, from about 0.05 to about 12%, from about 0.1 to about 10%, from about 0.2 to about 8%, from about 0.3 to about 7% or from about 0.4 to about 5% by weight, based on the total weight of the electrolyte composition.
E29. A composition according to any of the preceding embodiments where the weight:weight ratio of the one or more cyclic sulfate compounds to the one or more additives a)-i) is for instance about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1 or about 9:1 and ratios therebetween.
E30. A composition according to any of the preceding embodiments comprising at least two different compounds selected from the group consisting of a)-i).
E31. A composition according to embodiment 30 where the at least two different compounds are of two different groups of a)-i).
E32. A composition according to embodiment 31 comprising one or more compounds selected from the group consisting of a) tertiary amines, b) amides, c) pyridine compounds, d) organic phosphorus compounds and e) phosphonitrilic compounds and comprising one or more compounds selected from the group consisting of f) organoboron compounds, g) borate salts, h) anhydrides and i) nitriles.
E33. A composition according to embodiment 32 comprising one or more compounds selected from the group consisting of b) organic amides and one or more compounds selected from the group consisting of g) borate salts.
E34. A composition according to embodiment 32 comprising one or more compounds selected from the group consisting of b) organic amides and one or more compounds selected from the group consisting of h) anhydrides.
E35. A composition according to embodiment 32 comprising one or more compounds selected from the group consisting of b) organic amides and one or more compounds selected from the group consisting of i) nitriles.
E36. A composition according to any of embodiments 30 to 35 where the weight:weight ratio of the at least two different compounds is for instance about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1 or about 9:1 and ratios therebetween.
E37. A composition according to any of the preceding embodiments comprising one or more further additives selected from the group consisting of solid electrolyte interface improvers, cathode protection agents, LiPF₆ stabilizers, overcharge protectors, flame retardants, Li deposition improvers, solvation enhancers, corrosion inhibitors, wetting agents and viscosity adjusting agents.
E38. A composition according to any of the preceding embodiments further comprising one or more further additives selected from the group consisting of formulae (1) to (12)

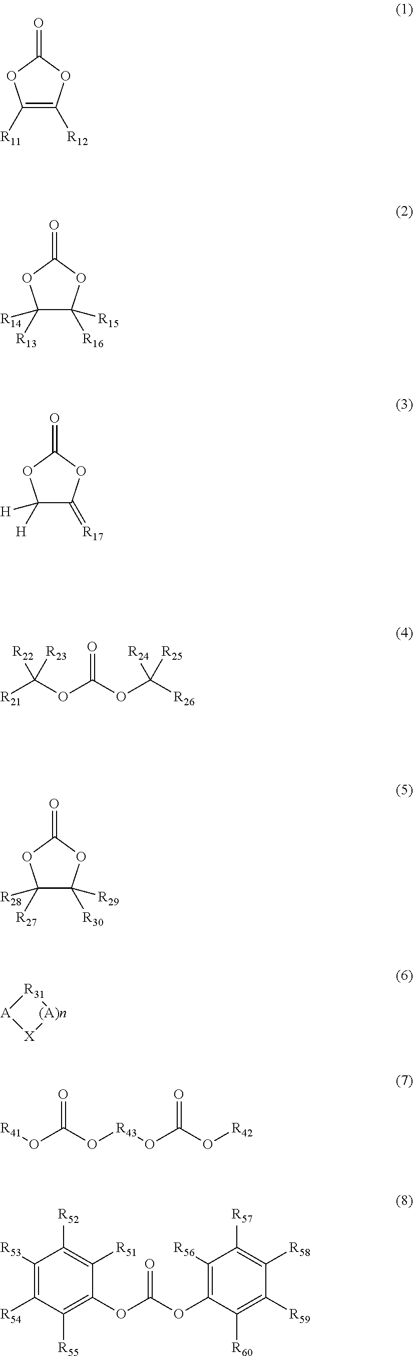

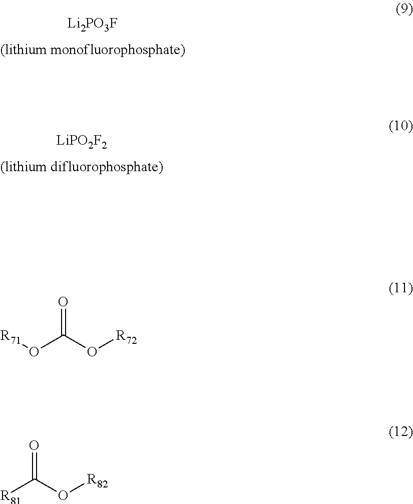

where
R₁₁ and R₁₂ are independently hydrogen, halogen, alkyl or haloalkyl;
R₁₃, R₁₄, R₁₅ and R₁₆ are independently hydrogen, halogen, alkyl, haloalkyl, vinyl or allyl, where at least one of R₁₃ to R₁₆ is vinyl or allyl;
R₁₇ is hydrogen or alkyl;
R₂₁ to R₂₆ are independently hydrogen, halogen, alkyl or haloalkyl, where at least one of R₂₁ to R₂₆ is halogen or haloalkyl;
R₂₇ to R₃₀ are independently hydrogen, halogen, alkyl or haloalkyl, where at least one of R₂₇ to R₃₀ is halogen or haloalkyl;
R₃₁ is an optionally substituted C₁-C₆alkylene, an optionally substituted C₂-C₆alkenylene or an optionally substituted cycloalkylene, A is C═O, SO or SO₂, n is 0 or 1 and X is oxygen (O) or sulfur (S);
R₄₁ and R₄₂ are independently an optionally substituted C₁-C₆alkyl, an optionally substituted C₂-C₆alkenyl or an optionally substituted C₂-C₆alkynyl and R₄₃ is an optionally substituted C₁-C₆alkylene, an optionally substituted C₂-C₃alkenylene, an optionally substituted C₂-C₃alkynylene or an optionally substituted cycloalkylene, where the substituent is for instance halogen or C₁-C₆alkyl;
R₅₁ to R₆₀ independently are an optionally substituted C₁-C₁₈alkyl, alkenyl, alkynyl, alkoxy or alkylamino, or two of R₅₁-R₆₀ together are hydrocarbylene, where the substituent halogen atom or C₁-C₆alkyl;
R₇₁ and R₇₂ are independently alkyl or haloalkyl; and
R₈₁ and R₈₂ are independently alkyl.
E39. A composition according to any of the preceding embodiments comprising one or more further additives selected from the group consisting of vinylene carbonate (1,3-dioxol-2-one), 4-vinyl-1,3-dioxolan-2-one, 4-fluoro-1,3-dioxolan-2-one, methylene ethylene carbonate, 1,3-propane sultone, 1,4-butyl sultone, prop-1-ene-1,3-sultone, 4-(4-methyl)-1,3,2-dioxathiolane-2-oxide) and 1,5,2,4-dioxadithiane-2,2,4,4-tetraoxide.
E40. A composition according to any of the preceding embodiments comprising vinylene carbonate as a further additive.
E41. A composition according to any of the preceding embodiments comprising one or more further additives selected from the group consisting of ionic liquids.
E42. A composition according to embodiment 41 where the ionic liquids comprise a cation selected from the group consisting of ammonium and phosphonium ions, for example imidazolium or pyrrolidinium ions, for instance 1-ethyl-3-methylimidazolium, 1-hexyl-3-methylimidazolium, 1-butyl-1-methylpyrrolidinium or trihexyl(tetradecyl)phosphonium.
E43. A composition according to embodiments 41 or 42 where the ionic liquids comprise an anion selected from the group consisting of carboxylates, imides, methides, borates, phosphates, phosphinates, phosphonates, sulfonates and aluminates.
E44. A composition according to any of embodiments 41 to 43 where the ionic liquids comprise a cation selected from the group consisting of formulae (a)-(h)

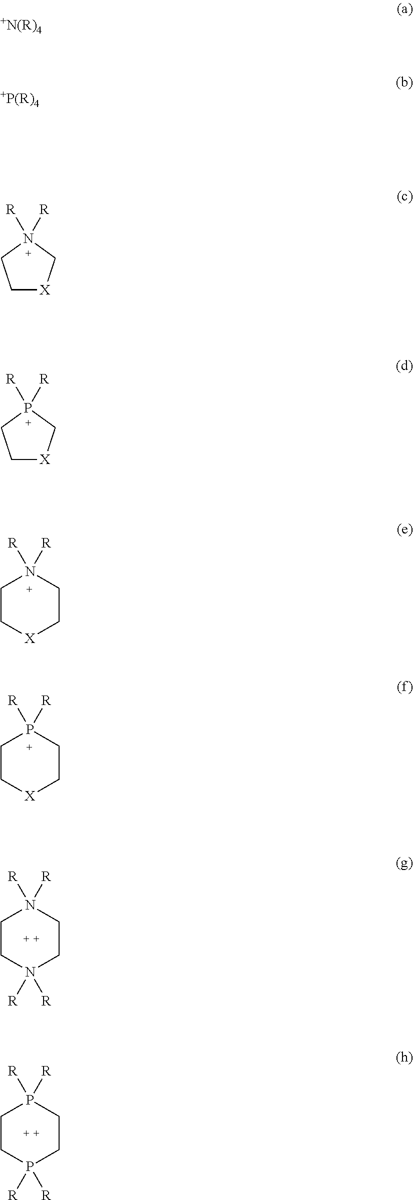

where
each R is independently H or C₁-C₁₆alkyl, for instance methyl, ethyl or propyl,
X is CH₂, O, S or NR where R is H or C₁-C₁₆alkyl, for instance H, methyl, ethyl or propyl
and comprise an anion selected from the group consisting of

[F_{z}B(CₘF2ₘ₊₁)_{4-z}]⁻,

[F_{y}P(CₘF₂ₘ₊₁)_{6-y}]⁻,

[(CₘF₂ₘ₊₁)₂P(O)O]⁻,

[CₘF₂ₘ₊₁P(O)O₂]²⁻,

[O—C(O)—CₘF₂ₘ₊₁]⁻,

[O—S(O)₂—CₘF₂ₘ₊₁]⁻,

[N(C(O)—CₘF₂ₘ₊₁)₂]⁻,

[N(S(O)₂—CₘF₂ₘ₊₁)₂]⁻,

[N(C(O)—CₘF₂ₘ₊₁)(S(O)₂—CₘF₂ₘ₊₁)]⁻,

[N(C(O)—CₘF₂ₘ₊₁)(C(O)F)]⁻,

[N(S(O)₂—CₘF₂ₘ₊₁)(S(O)₂F)]⁻,

[N(S(O)₂F)₂]⁻,

[C(C(O)—CₘF₂ₘ₊₁)₃]⁻,

[C(S(O)₂—CₘF₂ₘ₊₁)₃]⁻,

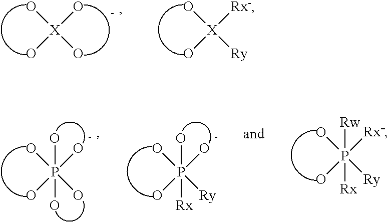

where
y is an integer of 1 to 5 and m is an integer of 1 to 8, for instance 1 to 4,
where any one CF₂ group may be replaced by O, S(O)₂, NR or CH₂,
where [symbol] O is independently a bidentate group derived from the —OH groups of a 1,2- or 1,3-diol, a 1,2- or 1,3-dicarboxylic acid or from a 1,2- or 1,3-hydroxycarboxylic acid,

### X is B or Al,

R_{w}, Rₓ, R_{y} and R_{z} are independently halogen, C₁-C₂₀perfluoroalkyl, C₁-C₂₀alkoxy, C₁-C₂₀alkoxy which is partly or fully fluorinated, C₁-C₂₀alkyl-COO, C₁-C₂₀alkyl-COO which is partly or fully fluorinated.
E45. A composition according to any of embodiments 41 to 44 where the ionic liquids comprise an anion selected from the group consisting of F₂P(C₂F₅)₄⁻, F₃P(C₂F₅)₃⁻, F₄P(C₂F₅)₂⁻, F₂P(C₃F₇)₄⁻, F₃P(C₃F₇)₃⁻, F₄P(C₃F₇)₂⁻, F₂P(C₄F₉)₄⁻, F₃P(C₄F₉)₃⁻, F₄P(C₄F₉)₂⁻, perfluoroalkylcarboxylate, perfluoroalkylsulfonate, bis(perfluoroalkylsulfonyl)imide, (perfluoroalkylsulfonyl)(perfluoroalkylcarboxyl)imide, tris(perfluoroalkylsulfonyl)methide, trifluoroacetate, trifluoromethanesulfonate (triflate), bis(trifluoromethylsulfonyl)imide, tris(trifluoromethylsulfonyl)methide, spiro-oxo borates and spiro-oxo phosphates, for example bisoxalatoborate (BOB), difluorooxalatoborate (dFOB), di(trifluoroacetato)oxalatoborate (d(Ac)OB), trisoxalatophosphate, tetrafluorooxalatophosphate or di(trifluoroacetato)oxalatoaluminate.
E46. A composition according to any of embodiments 37 to 45 where the further additives are present, in total, from about 0.01% to about 15%, from about 0.05 to about 10%, from about 0.1 to about 7% or from about 0.2 to about 5%, by weight, based on the total weight of the electrolyte composition, for instance, the further additives are present, in total, at a level of about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4 or about 2.5 percent by weight, based on the total weight of the electrolyte composition.
E47. A rechargeable lithium ion battery comprising at least one anode, at least one cathode, a separator disposed between the electrodes and an electrolyte composition according to any of the preceding embodiments in contact with the electrodes.
E48. Use of one or more additives selected from the group consisting of a) tertiary amines, b) amides, c) pyridine compounds, d) organophosphorus compounds, e) phosphonitrilic compounds, f) organoboron compounds, g) borate salts, h) anhydrides and i) nitriles in an electrolyte composition for lithium ion batteries containing an organic solvent, one or more lithium salts and one or more cyclic sulfate additives towards preventing color formation of the composition.
E49. The “use” embodiment 48 modified by any features of embodiments 2 to 46.
E50. Use of an electrolyte composition according to any of embodiments 1 to 46 as an electrolyte in a lithium ion battery.

### Example 1 Electrolyte Color Stability

Electrolyte compositions are prepared under an argon atmosphere in a dry box with a 1:1:1 weight ratio of ethylmethyl carbonate (EMC), diethyl carbonate (DEC) and ethylene carbonate (EC) solvent containing 1 mol/L LiPF₆. The compositions are prepared in glass vials with teflon screw caps. The comparative and inventive formulations 1-7 further contain additives as listed below. Percent additives are weight percent, based on the total composition.

comparative formulation 1: no additives

comparative formulation 2: 1% DTD

formulation 1: 1% DTD, 1% DMAM

formulation 2: 1% DTD, 1% LiBOB

formulation 3: 1% DTD, 1% SA

formulation 4: 1% DTD, 1% SN

formulation 5: 1% DTD, 1% DMAM, 1% LiBOB

formulation 6: 1% DTD, 1% DMAM, 1% SA

formulation 7: 1% DTD, 1% DMAM, 1% SN

DTD is 1,3,2-dioxathiolane 2,2-dioxide; DMAM is N,N-dimethyl acetamide; LiBOB is lithium bis(oxalato) borate; SA is succinic anhydride and SN is succinonitrile.

The electrolyte formulations are stored at 50° C. in the glass vial under an inert atmosphere and observed for color change. Results are below.

| formulation | day | color |
|---|---|---|
| comparative 1 | 5 | clear |
| | 10 | clear |
| | 13 | clear |
| comparative 2 | 5 | brown |
| | 10 | dark brown |
| inventive 1 | 5 | clear |
| | 10 | clear |
| | 13 | light brown |
| inventive 2 | 5 | light brown |
| | 10 | brown |
| inventive 3 | 5 | light brown |
| | 10 | brown |
| inventive 4 | 5 | light brown |
| | 10 | brown |
| inventive 5 | 5 | clear |
| | 10 | clear |
| | 13 | clear |
| inventive 6 | 5 | clear |
| | 10 | clear |
| | 13 | clear |
| inventive 7 | 5 | clear |
| | 10 | clear |
| | 13 | clear |

Comparative compositions 1 and 2 show that an electrolyte containing DTD results in a dark brown color upon storage. Inventive compositions 1-7, containing one or more additives of the invention, result in much less color upon storage.

### Example 2 Cycle Life

Cathode active material slurry is prepared by dispersing NCM(111) cathode active material, polyvinylidene fluoride binder and carbon conductive material in N-methyl-2-pyrrolidone solvent in a weight ratio of 90:5:5. The cathode is formed by coating the slurry onto 20 micron thick aluminum foil followed by drying and rolling the coated foil. Anode active material slurry is prepared by mixing synthetic graphite active material, styrene-butadiene rubber binder and carboxymethylcellulose thickener in a weight ratio of 96:2:2 and dispersing the mixture in water. The anode slurry is coated onto a 10 pm thick copper foil followed by drying and rolling the coated foil. A 16 pm thick polyethylene separator is placed between the electrodes and the assembly is wound and pressurized. The assembly is inserted into an open end of a prismatic aluminum can.

Electrolyte compositions are injected into the can to complete preparation of the lithium ion cells. The electrolyte compositions comparative 3 and inventive 8-14 are prepared under an argon atmosphere in a dry box with a 1:1:1 weight ratio of ethylmethyl carbonate (EMC), diethyl carbonate (DEC) and ethylene carbonate (EC) solvent containing 1 mol/L LiPF₆. The electrolyte formulations contain further additives as listed below. Percent additives are weight percent, based on the total composition.

comparative formulation 3: 1% DTD, 1% VC

formulation 8: 1% DTD, 1% DMAM, 1% VC

formulation 9: 1% DTD, 1% LiBOB, 1% VC

formulation 10: 1% DTD, 1% SA, 1% VC

formulation 11: 1% DTD, 1% SN, 1% VC

formulation 12: 1% DTD, 1% DMAM, 1% LiBOB, 1% VC

formulation 13: 1% DTD, 1% DMAM, 1% SA, 1% VC

formulation 14: 1% DTD, 1% DMAM, 1% SN, 1% VC

DTD is 1,3,2-dioxathiolane 2,2-dioxide; DMAM is N,N-dimethyl acetamide; LiBOB is lithium bis(oxalato) borate; SA is succinic anhydride and SN is succinonitrile; VC is vinylene carbonate.

Cell cycle life is tested at 45° C. via an initial charge/discharge followed by charging at a constant current rate of 1 C (700 mA) to 4.15V, then charging at a constant voltage of 4.15V until the current is less than or equal to 35 mA. The cell is then discharged at a constant current rate of C (700 mA) until the cut-off voltage 3.0V is reached. Capacity retention after 300 cycles at 45° C. for the electrolyte formulations are below.

| formulation | capacity retention (%) |
|---|---|
| comparative 3 | 81.8 |
| inventive 8 | 81.5 |
| inventive 9 | 86.3 |
| inventive 10 | 82.7 |
| inventive 11 | 85.5 |
| inventive 12 | 83.2 |
| inventive 13 | 82.3 |
| inventive 14 | 82.5 |

The inventive electrolyte compositions provide similar or better electrochemical performance compared to a comparative example.

1. An electrolyte composition stabilized against color formation comprising an organic solvent, one or more lithium salts, one or more cyclic sulfate additives and
one or more additives selected from the group consisting of a) tertiary amines, b) amides, c) pyridine compounds, d) organophosphorus compounds, e) phosphonitrilic compounds, f) organoboron compounds, g) borate salts, h) anhydrides and i) nitriles,
where the cyclic sulfate additives are of formula 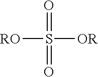
where the R groups together are hydrocarbylene.

2. A composition according to claim 1 where the cyclic sulfate additives are selected from the group consisting of 1,3,2-dioxathiolane 2,2-dioxide, 1,3-propanediol cyclic sulfate, propylene sulfate (4-methyl-1,3,2-dioxathiolane 2,2-dioxide), 4-ethyl-1,3,2-dioxathiolane 2,2-dioxide and 4-propyl-1,3,2-dioxathiolane 2,2-dioxide.

3. A composition according to claim 1 where the organic solvent comprises one or more solvents selected from the group consisting of organic carbonates, sulfones, sulfoxides, esters, lactones, ethers and glymes.

4. A composition according to claim 1 where the organic solvent comprises one or more organic carbonates selected from the group consisting of ethylene carbonate, propylene carbonate, trimethylene carbonate, 1,2-butylene carbonate, dimethyl carbonate, diethyl carbonate, ethylmethyl carbonate, dipropyl carbonate, vinylene carbonate, difluoroethylene carbonate and monofluoroethylene carbonate.

5. A composition according to claim 1 where the lithium salts are selected from the group consisting of LiPF₆, LiClO₄, LiN(CF₃SO₂)₂, LiAsF₆ and LiCF₃SO₃ and where the lithium salts in total are present in the organic solvent at a level of from about 0.5 M to about 2.5 M.

6. A composition according to claim 1 comprising one or more additives selected from the group consisting of
a) tertiary amines of formula NR₁R₂R₃ where R₁, R₂ and R₃ are each hydrocarbyl or where R₁ and R₂ and/or R₁ and R3 and/or R₂ and R₃ together are hydrocarbylene;
b) phosphoramides or organic amides of formula R₁R₂NC(O)R₃ where R₁, R₂ and R₃ are each hydrogen or hydrocarbyl or R₁ and R₂ and/or R₁ and R₃ and/or R₂ and R₃ together are hydrocarbylene;
c) pyridine compounds of formula 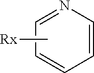
where Rx is hydrogen, halogen or hydrocarbyl;
d) organophosphorus compounds of formula 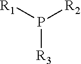
where R₁, R₂ and R₃ are independently hydrocarbyl or R₁ and R₂ and/or R₁ and R₃ and/or R₂ and R₃ together are hydrocarbylene;
e) phosphonitrilic compounds of formula 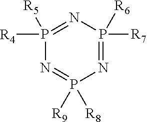
where R₄, R₅, R₆, R₇, R₈ and R₉ are independently alkoxy, halogen or hydrocarbyl;
f) organoboron compounds of formula 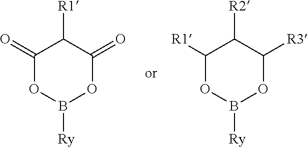
where Ry is hydrogen, alkoxy or hydrocarbyl and R1′, R2′ and R3′ are hydrogen or hydrocarbyl;
g) borate salts;
h) phosphonic anhydrides or anhydrides of formula 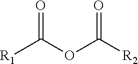
where R₁ and R2 are independently hydrocarbyl or together are hydrocarbylene; and
i) nitriles of formula
R₁—CN or NC—Rz-CN
where R1 is hydrocarbyl and Rz is hydrocarbylene.

7. A composition according to claim 6 comprising one or more additives selected from the group consisting of
a) triethylamine, tributylamine, N,N,N′,N″,N″-pentamethyldiethylenetriamine, N,N,N′,N″,N′″,N″″-hexamethyltriethylenetetraamine, N,N,N′,N′-tetramethylethylenediamine or triethylenediamine;
b) N,N-dimethyl acetamide, N,N-dimethyl-trifluoroacetamide, N,N-diethyl-trifluoroacetamide, N-methyl-trifluoracetamide, 1-methyl-2-pyrrolidinone or hexamethylphosphoramide;
c) pyridine, 2,2-dipyridyl, 4,4′-dipyridyl, 4-bromopyridine, 3-chloropyridine, 2-vinylpyridine or 4-tert-butylpyridine;
d) triphenylphosphine, triethylphosphine, tripropylphosphine, triisobutylphosphine, trihexylphosphine, trioctylphosphine, tributylphosphine, tris-pentafluorophenylphosphine or tris(4-fluorophenyl) phosphine;
e) hexamethoxycyclotriphosphazene, phosphonitrilic chloride trimer or phosphonitrilic fluoride trimer;
f) 4,4,6-trimethyl-1,3,2-dioxaborinane, 2-methoxy-4,4,6-trimethyl-1,3,2-dioxaborinane, 2-ethoxy-4,4,6-trimethyl-1,3,2-dioxaborinane, 2-isopropoxy-4,4,6-trimethyl-1,3,2-dioxaborinane, 2-butoxy-4,4,6-trimethyl-1,3,2-dioxaborinane, vinylboronic acid 2-methyl-2,4-pentanediol ester, phenylboronic acid neopentylglycol ester or phenylboronic acid 1,3-propanediol ester;
g) alkali metal salts of borates selected from the group consisting of orthoborate, tetrahydroxyborate, tetraborate, tetraphenylborate, [B(3,5-(CF₃)₂C₆H₃)₄]⁻, B(C₂O₄)₂⁻, difluoro(oxalato)borate, di(trifluoroacetato)oxalatoborate, B(C₆F₅)₄⁻ and BF₄⁻;
h) succinic anhydride, glutaric anhydride, phthalic anhydride, acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride or propylphosphonic anhydride; and
i) acetonitrile, propionitrile, butyronitrile, isobutyronitrile, 1,2-dicyanoethane, succinonitrile, 1,5-dicyanopentane, hexanedinitrile (adiponitrile), glutaronitrile or fumaronitrile.

8. A composition according to claim 1 where the cyclic sulfate compounds together with the compounds a)-i), in total, are present from about 0.01 to about 15%, by weight, based on the total weight of the electrolyte composition and where the weight:weight ratio of the one or more cyclic sulfate compounds to the one or more additives a)-i) is from about 1:9 to about 9:1.

9. A composition according to claim 1 comprising
one or more compounds selected from the group consisting of a) tertiary amines, b) amides, c) pyridine compounds, d) organic phosphorus compounds and e) phosphonitrilic compounds
and
one or more compounds selected from the group consisting of f) organoboron compounds, g) borate salts, h) anhydrides and i) nitriles.

10. A composition according to claim 9 where the weight:weight ratio of the one or more compounds selected from the group consisting of a) to e) to the one or more compounds selected from the group consisting f) to i) is from about 1:9 to about 9:1.

11. A composition according to claim 1 further comprising one or more further additives selected from the group consisting of formulae (1) to (12) 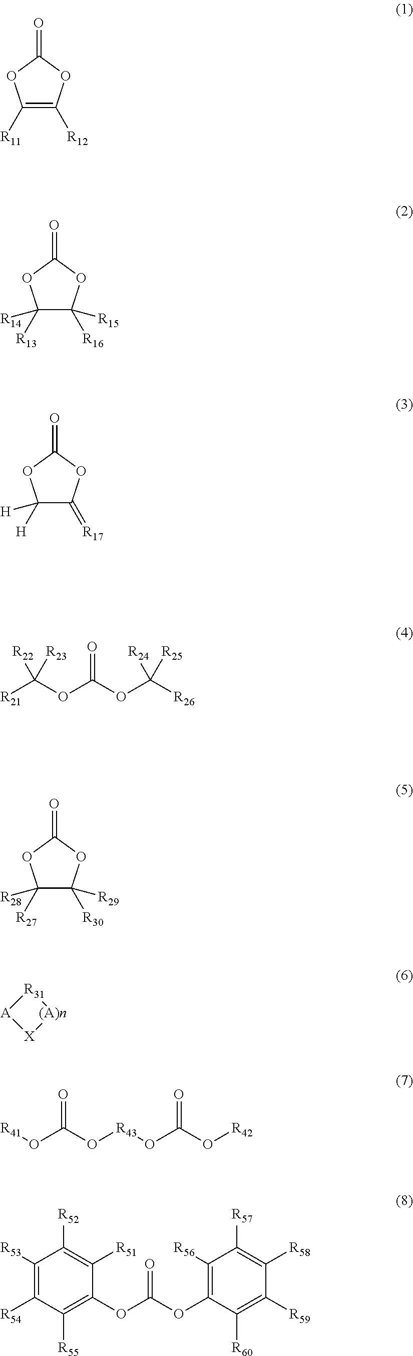 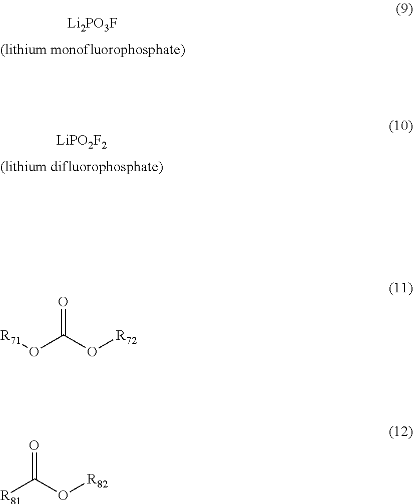
where
R₁₁ and R₁₂ are independently hydrogen, halogen, alkyl or haloalkyl;
R₁₃, R₁₄, R₁₅ and R₁₆ are independently hydrogen, halogen, alkyl, haloalkyl, vinyl or allyl, where at least one of R₁₃ to R₁₆ is vinyl or allyl;
R₁₇ is hydrogen or alkyl;
R₂₁ to R₂₆ are independently hydrogen, halogen, alkyl or haloalkyl, where at least one of R₂₁ to R₂₆ is halogen or haloalkyl;
R₂₇ to R₃₀ are independently hydrogen, halogen, alkyl or haloalkyl, where at least one of R₂₇ to R₃₀ is halogen or haloalkyl;
R₃₁ is an optionally substituted C₁-C₆alkylene, an optionally substituted C₂-C₆alkenylene or an optionally substituted cycloalkylene, A is C═O, SO or SO₂, n is 0 or 1 and X is oxygen (O) or sulfur (S);
R₄₁ and R₄₂ are independently an optionally substituted C₁-C₆alkyl, an optionally substituted C₂-C₆alkenyl or an optionally substituted C₂-C₆alkynyl and R₄₃ is an optionally substituted C₁-C₆alkylene, an optionally substituted C₂-C₆alkenylene, an optionally substituted C₂-C₆alkynylene or an optionally substituted cycloalkylene, where the substituent is for instance halogen or C₁-C₆alkyl;
R₅₁ to R₆₀ independently are an optionally substituted C₁-C₁₈alkyl, alkenyl, alkynyl, alkoxy or alkylamino, or two of R₅₁-R₆₀ together are hydrocarbylene, where the substituent halogen atom or C₁-C₆alkyl;
R₇₁ and R₇₂ are independently alkyl or haloalkyl; and
R₈₁ and R₈₂ are independently alkyl.

12. A composition according to claim 1 comprising one or more further additives selected from the group consisting of vinylene carbonate (1,3-dioxol-2-one), 4-vinyl-1,3-dioxolan-2-one, 4-fluoro-1,3-dioxolan-2-one, methylene ethylene carbonate, 1,3-propane sultone, 1,4-butyl sultone, prop-1-ene-1,3-sultone, 4-(4-methyl)-1,3,2-dioxathiolane-2-oxide), 1,5,2,4-dioxadithiane-2,2,4,4-tetraoxide and ionic liquids.

13. A composition according to claim 11 where the further additives are present from about 0.01% to about 15%, based on the total weight of the electrolyte composition.

14. A rechargeable lithium ion battery comprising at least one anode, at least one cathode, a separator disposed between the electrodes and an electrolyte composition according to claim 1 in contact with the electrodes.

15. (canceled)
